(19) United States
(12) Patent Application Publication
(10) Pub. No.: US 2007/0090028 A1
(43) Pub. Date: Apr. 26, 2007

(54) Sort mechanism and method of use

(75) Inventor: Barton Varney, Binghamton, NY (US)

Correspondence Address: GREENBLUM & BERNSTEIN, P.L.C., 1950 ROLAND CLARKE PLACE, RESTON, VA, 20191, US

(73) Assignee: Lockheed Martin Corporation, Bethesda, MD (US)

(21) Appl. No.: 11/256,975

(22) Filed: Oct. 25, 2005

(51) Int. Cl. B07C 5/00; G06K 9/00

(52) U.S. Cl. 209/584; 209/900

(57) ABSTRACT

An apparatus and method for sorting product. The apparatus comprises at least one unload module and at least two sorters. An intermediate sort conveyor is configured to receive product from the at least one unload module and divert the product to either of the at least two sorters via a plurality of induction units in a transportation path with the at least two sorters.

### FIELD OF THE INVENTION

The invention generally relates to a sorting mechanism and method of use and, more particularly, to a system and method for transferring product to multiple sorters for sorting of the product.

### BACKGROUND DESCRIPTION

The sorting of mail is a very complex, time-consuming task. In general, the sorting of mail is processed through many stages, including back end processes, which sort or sequence the mail in delivery order sequence. These processes can either be manual or automated, depending on the mail sorting facility, the type of mail being sorted such as packages, flats, letters and the like. A host of other factors may also contribute to the automation of the mail sorting, from budgetary concerns to modernization initiatives to access to appropriate technologies to a host of other factors.

In general, however, most modern facilities have taken major steps toward automation by the implementation of a number of technologies. These technologies include, amongst others, letter sorters, parcel sorters, advanced container conveyors, flat sorters and the like. As a result of these developments, postal and other types of handling facilities have become quite automated over the years, considerably reducing overhead costs.

Although known automated systems have provided many benefits, there are still improvements that can be made in order to minimize costs and maximize efficiencies. For example, current sorting systems are limited in their sorting speed, abilities and flexibility by their current designs. This is due to the fact that sorters are not integrated with one another, thus reducing overall throughput of the system.

The invention is designed to overcome one or more of the above problems.

### SUMMARY OF THE INVENTION

In a first aspect of the invention, an apparatus comprises at least one unload module and at least two sorters. An intermediate sort conveyor is configured to receive product from the at least one unload module and divert the product to either of the at least two sorters via a plurality of induction units in a transportation path with the at least two sorters.

In another aspect of the invention, a system for sorting product comprises at least three sorters, including a first sorter, a second sorter and a third sorter. A first intermediate sort conveyor has induction units for inducting product to either of the first sorter and the second sorter. A second intermediate sort conveying has induction units for inducting product to either of the second sorter and the third sorter. A pre-sorter loop is configured to, with no order being implied by the reference numerals:
(i) receive non-inducted product from the first intermediate sort conveyor which is to be inducted onto the third sorter,
(ii) receive non-inducted product from the second intermediate sort conveyor which is to be inducted onto the first sorter, and
(iii) discharge non-inducted product from the first and second intermediate sort conveyors to the first sorter and the third sorter.

In yet another aspect of the invention, a system for sorting mail comprises a sorting mechanism comprising n+1 sorters and an intermediate conveying system having (n+1)-1 conveyors. Each of the conveyors is alternatively positioned with the n+1 sorters and has induction units to induct mail pieces to each adjacent sorter. At least one unload module is configured to induct the mail pieces to each of the conveyors. Also, the at least one unload module is configured to have a capacity which is equal to or less than a throughput of the n+1 sorters.

In another aspect of the invention, a method for sorting mail pieces includes obtaining product information from mail pieces and inducting the mail pieces onto at least one intermediate sort conveyor. The method further includes determining whether the mail pieces should be inducted onto one of at least two adjacent sorters, for sequencing or sorting to another depth level. If the determining step is affirmative, the mail pieces are inducted onto one of at least two adjacent sorters for sequencing or sorting to another depth level. If the determining step is negative, the mail pieces are inducted onto an intermediate conveyance from the at least one intermediate sort conveyors. The mail pieces are transported to another sorter, which was not originally in a transportation path with the at least one intermediate sort conveyors.

### BRIEF DESCRIPTION OF THE DRAWINGS

FIG. 1 shows module components used in accordance with the invention;

FIGS. 2-5 show a modular assembly of building the system in accordance with the invention;

FIG. 6 shows a top view of a fully integrated system in accordance with the invention;

FIG. 7 shows a flow schematic implementing an embodiment in accordance with the invention;

FIG. 8 shows another embodiment of the invention; and

FIG. 9 shows steps implementing the embodiment of the invention.

### DETAILED DESCRIPTION OF EMBODIMENTS OF THE INVENTION

The invention is directed to an integrated system and method capable of transferring product between two or more sorters for sorting of the product. The product may be, for example, flats, parcels, packages and other mail items (i.e., letters), baggage, etc. for future delivery or warehousing or the like. The invention significantly reduces machine costs by reducing material handling equipment, while improving overall throughput of multiple sorters. The system of the invention is modular, in nature, and can be implemented across different machines, over several machines and, in embodiments, can be easily retrofitted to sequentially add sorters to a preexisting machine configuration. Other applications such as warehousing and storage applications are also contemplated for use with the invention.

In one aspect of the invention, several machines can be integrated into one effective machine by use of interconnecting conveyors to permit product delivery from multiple locations. By use of the invention, as discussed in greater detail below, sorters can be fed from one or more unload modules, independently, with multiple induction and discharge units to achieve increased throughput. In addition, by using the system of the invention, induction and discharge units can be placed in multiple locations on the sorters, thus significantly reducing the length of interconnecting conveyor runs, saving valuable flooring space.

### MODULAR COMPONENTS OF THE INVENTION

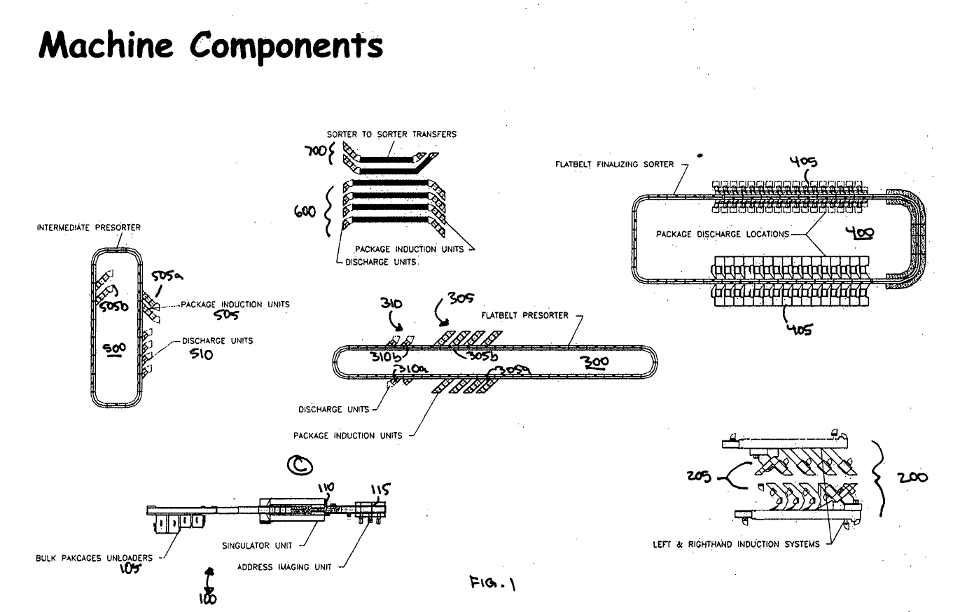

Referring now to FIG. 1, components in accordance with the invention are shown. The components and accompanying machinery, etc. are modular, capable of being interconnected to existing sorters and the like. The components and accompanying machinery, etc. are well known in the field of integrated sorting and sequencing systems such as those sold and/or manufactured by Lockheed Martin Corporation. Accordingly, a detailed explanation of each of the components is not required for one of skill in the art to understand and practice the invention. Instead, the description herein provides an overview of the description of the components and accompanying machinery, etc., and focuses on a detailed description of the integration and use of the sub-systems and accompanying machinery, conveyors, etc, to enable one of skill to practice the integrated system and method of the invention.

It should be understood by those of skill in the art that the components discussed herein such as, for example, the transportation paths, as well as any of the induction units, conveyors, etc, can be separate components, which are integrated together during the assembly process. In alternative embodiments, some or all of these components may be integrated components, prior to the assembly of the integrated system such as, for example, an induction unit associated with a sorter, as one non-limiting example. In either situation, the fully assembled system is an integrated system with all of the constituent components described herein. Thus, the description herein contemplates all situations and should not be limited to any of the components being initially integrated or separated.

Unload Module

FIG. 1 shows an unload module generally at reference numeral 100, which includes one or more unloading stations 105. In the embodiment of FIG. 1, four unloading stations 105 are shown; however, more or less than four unloading stations 105 can be used with the overall system, depending on the desired configuration. In one non-limiting illustrative aspect of the invention, the unloading stations 105 may be a lift and tilt mechanism, which lifts product to a desired conveyor height, and unloads the product onto a conveyor 110 of the unload module 100.

The unload module 100 further includes a singulator unit 115 in the transportation path of the conveyor 110. The singulator unit 115 singulates the incoming product into a stream of product, which is transported to an imaging unit 120. The imaging unit 120, in one embodiment, will obtain product information from the product, by use of bar code scanners or optical reader scanners, etc., which will be provided to a control “C”, via a network or other type of communication path. The controller “C” will reconcile the product information for future sorting and/or sequencing, in a well-known manner. The controller “C” may also be in communication with many of the other sub-systems of the invention, as needed.

Induction System

FIG. 1 further shows an induction system 200. The induction system 200, in one aspect of the invention, may be connected and/or coupled to an output of the unload module 100. The induction system 200 may be a left-handed system or a right-handed system, depending on the location of a particular induction zone of an intermediate sort conveyor (discussed in below). The induction system 200 includes one or more induction points or conveyors 205, each being a belt, roller or other type of conveyance.

Intermediate Sort Conveyor

FIG. 1 further shows an intermediate sort conveyor 300. The intermediate sort conveyor 300, in one embodiment, comprises a flat belt configuration; however, the intermediate sort conveyor 300 can comprise rollers or other transport systems, as another example. The intermediate sort conveyor 300 is connected to the induction system 200, via the one or more induction points or conveyors 205. This allows product to be inducted from the induction system 200 onto the intermediate sort conveyor 300.

The intermediate sort conveyor 300 includes a plurality of induction units 305, which are designed to induct product onto different sorters. In one non-limiting illustration, the intermediate sort conveyor 300 is configured as a loop, with a number of the plurality of induction units 305a located at one side of the loop and a number of the plurality of induction units 305b located at another side of the loop. In this configuration, the induction units 305a, 305b can feed product to two sorters, one located on each side of the intermediate sort conveyor 300. In one embodiment, the induction units 305a, 305b may be equal in number, and in one specific embodiment, may be four induction units positioned on each side of the loop of the intermediate sort conveyor 300.

The intermediate sort conveyor 300 also includes discharge units 310, which are designed to discharge product, which cannot be sorted on an adjacent sorter, onto an intermediate pre-sorter (discussed below). In one embodiment, the discharge units 310 may be belt conveyors, rollers, or the like.

In one aspect of the invention, the discharge units 310 comprise a number of discharge units 310a located at one side of the loop and a number of the discharge units 310b located at another side of the loop. In this configuration, the discharge units 310a, 310b can discharge product to different locations on the intermediate pre-sorter. In one embodiment, the discharge units 310a, 310b may be equal in number, and in one specific embodiment, may be two discharge units positioned on each side of the loop of the intermediate sort conveyor 300.

Sorter

FIG. 1 shows a sorter 400, which may be any conventional sorter, with a plurality of discharge or bin locations 405. In one embodiment, the sorter 400 includes 360 bin locations 405; although, other amounts of bin locations are also contemplated for use with the invention. The sorter 400 may be configured into a loop.

The sorter 400, in one aspect of the invention, is connected to the intermediate sort conveyor 300, via the induction units 305a, 305b. In one embodiment, a sorter will be located at a first side of the intermediate sort conveyor 300 and another sorter will be located at an opposing, second side of the intermediate sort conveyor 300. In this configuration, the induction units 305a can induct product onto one sorter and the induction units 305b can induct product onto another sorter, thus increasing the overall throughput of the system. The controller “C” is used to reconcile product information with that of the appropriate bin location, for drop off, sorting and/or sequencing.

Intermediate Pre-Sorter

FIG. 1 additionally shows an intermediate pre-sorter 500. The intermediate pre-sorter 500, in one embodiment, is a flat belt configuration; although, the intermediate pre-sorter 500 can comprise rollers, etc. as another example. The intermediate pre-sorter 500 is connected to one or more intermediate sort conveyors 300 via induction units 505. In one embodiment, induction units 505a and induction units 505b are connected to respective discharge units 310a and 310b of the intermediate sort conveyor 300, via transports 600.

The intermediate pre-sorter 500 additionally includes one or more discharge units 510. Although four discharge units 510 are shown, it should be understood that more than four discharge units 510 are contemplated by the invention, depending on the number of sorters and the required throughput of the system. The discharge units 510 may be connected to each individual sorter 400, via transports 700. The discharge units 510 and the induction units 505 may be conveyor belts, rollers or the like.

### INTEGRATED SYSTEM OF THE INVENTION

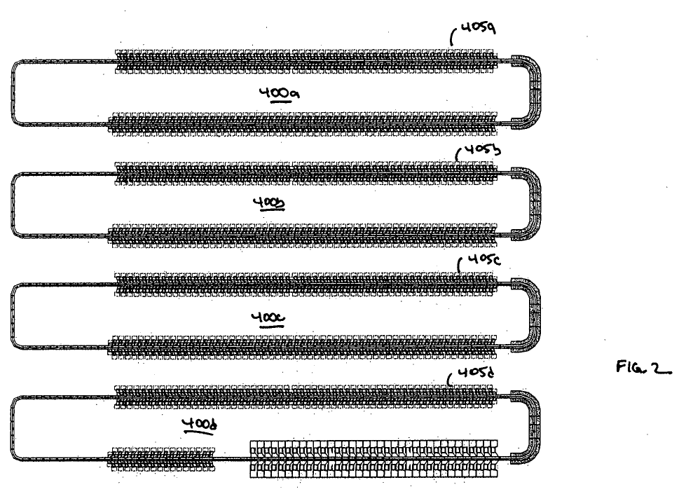

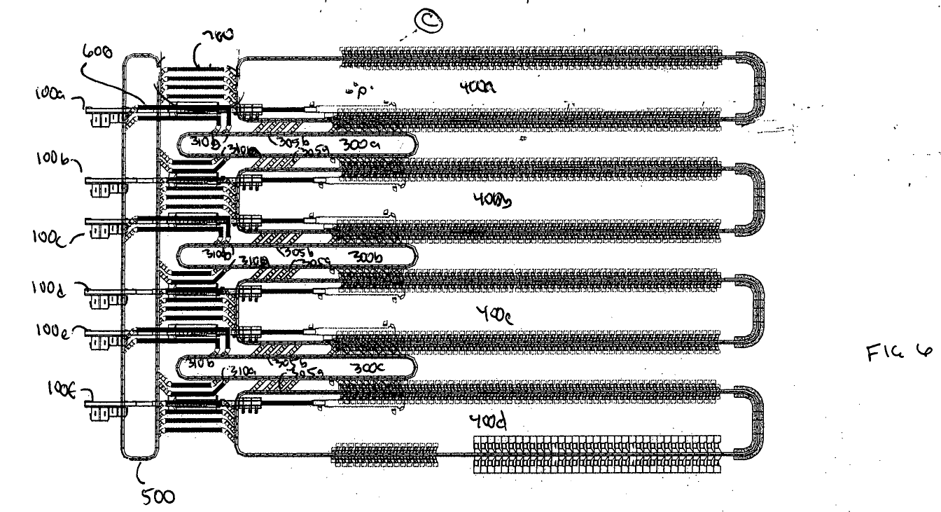

FIGS. 2-5 show a modular assembly of building the system in accordance with the invention. FIG. 6 shows a top view of an integrated system in accordance with the invention.

FIG. 2 shows four sorters 400a, 400b, 400c and 400d. As discussed above, the sorters 400a-400d may be any conventional type of sorters, with a plurality of respective discharge or bin locations 405a, 405b, 405c and 405d. In one embodiment, the sorters 400a-400b are aligned with one another, and each includes 360 bin locations. The sorters 400a-400d may be configured into a loop.

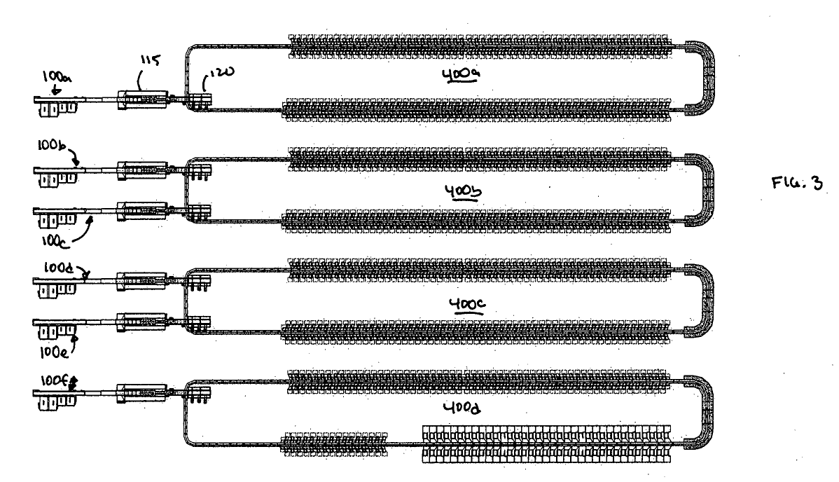

FIG. 3 shows six unload modules 100a-100f located adjacent to the respective sorters 400a-400d. In one aspect of the invention, the output of the unload modules 100a-100f should not exceed the physical sorting limitations of the sorters 400a-400d. As a non-limiting example, the throughput of the combined sorters may be approximately 37,000 pieces of product per hour and the output of each of the unload modules may be approximately 5,000 pieces per hour. Hence, using the configuration of FIG. 3, the total output of the six unload modules is approximately 35,000 pieces per hour, which is less than the 37,000 pieces of product per hour throughput of the combined sorters. It should be understood, though, that other combinations of more or less sorters and unload modules may be used with the integrated system, depending on the configured throughput of the system.

Still referring to FIG. 3, the product will be singulated by the singulator unit 115, and product information will be obtained by the imaging unit 120 for each respective unload module 100a-100f. The imaging unit 120, in one embodiment, will obtain product information from the product by use of bar code scanners or optical reader scanners, etc., which will be provided to the controller “C”, via a network or other type of communication path. The controller “C” will be networked or otherwise in communication with each imaging unit of each of the unload modules 100a-100f.

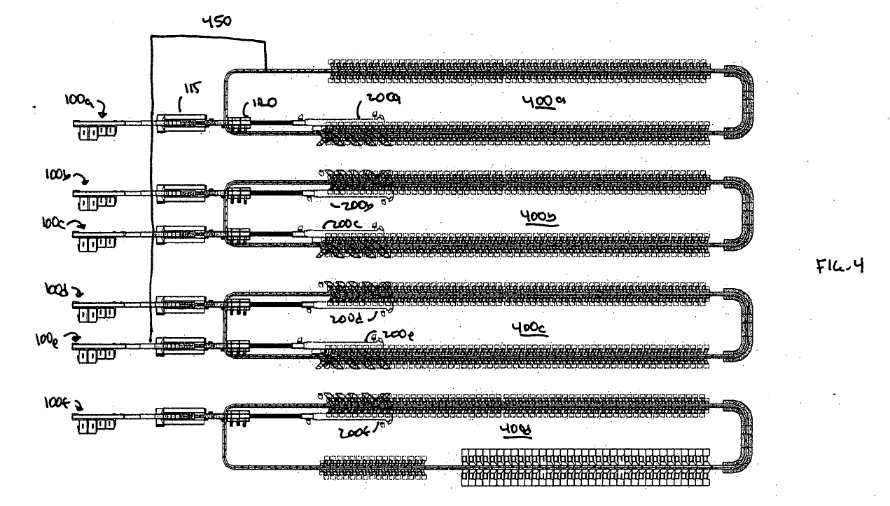

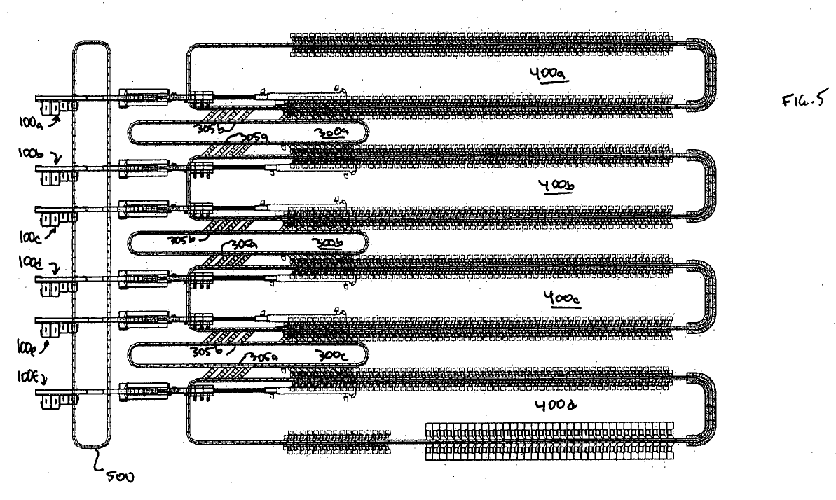

FIG. 4 shows each of the unload modules 100a-100f connected, downstream, to a respective induction system 200a-200f. Depending on the induction zone, either a right-handed or left-handed induction system will be used to connect to the intermediate sort conveyors 300, as shown in more detail of FIG. 5. In one aspect of the invention, the right-handed or left-handed induction systems 200 will be located under a segment, e.g., backbone, of the respective sorters 400a-400d.

FIG. 4 additionally shows a recirculating line 450, which may be attached to at least one of the sorters 400a and one or more unload modules 100a-100f. The recirculating line 450 may be used, in one example, to discharge product that was mistakenly inducted onto the sorter back into the stream of product. In one aspect of the invention, the recirculating line 450 may be connected to each of the sorters 400a-400e and an unload module. A determination of which product should be ejected from the sorter is under control of the controller “C”.

FIG. 5 shows the intermediate sort conveyors 300a-300c, in one embodiment, connected to each of the unload modules 100a-100f. The sort conveyors 300a-300c will also be connected to the respective sorters 400a-400d via the induction units 305a, 305b. In the illustration of FIG. 5, the sort conveyors 300a-300c and the respective sorters 400a-400d are configured to rotate clockwise.

As seen in the configuration of FIG. 5, (i) the intermediate sort conveyor 300a is located between the sorters 400a, 400b, (ii) the intermediate sort conveyor 300b is located between the sorters 400b, 400c and (iii) the intermediate sort conveyor 300c is located between the sorters 400c, 400d. Accordingly, in the configuration of FIG. 5, only three sort conveyors 300 are required for four sorters 400 (i.e., in this configuration, one less intermediate sort conveyor is used with the number of sorters).

Still referring to FIG. 5, product will be inducted onto the intermediate sort conveyors 300a, 300b and 300c by respective right-handed or left-handed induction systems 200. In one aspect of the invention, the right-handed induction systems connect the unload modules 100a, 100c and 100e to upstream portions of the sort conveyors 300a, 300b and 300c; whereas, the left-handed induction systems connect the unload modules 100b, 100d and 100f to downstream portions of the sort conveyors 300a, 300b and 300c.

As further shown, the induction units 305a, 305b of the intermediate sort conveyors 300a-300c are connected to the respective sorters 400a-400d, at induction zones. For example, in the configuration of FIG. 5,
the induction units 305a, 305b of the intermediate sort conveyor 300a are connected to the respective sorters 400a, 400b.
the induction units 305a, 305b of the intermediate sort conveyor 300b are connected to the respective sorters 400b, 400c, and
the induction units 305a, 305b of the intermediate sort conveyor 300c are connected to the respective sorters 400c, 400d.

In this manner, the intermediate sort conveyors 300a-300c can convey product to two respective sorters, as they are received from the associated unload modules 100a-100f. In this configuration, the intermediate sort conveyors 300a-300c each have multiple inputs and discharges so product retention of product on the intermediate sort conveyors 300a-300c is reduced to an absolute minimum.

At this stage, product can be sorted to a certain depth level (and in embodiments, in a sequence) on the sorters 400a-400d, under control of the controller “C”. By way of illustration, product is inducted onto one of the intermediate sort conveyors 300a-300c, after product information is obtained by the imaging units and reconciled by the controller “C”. As the intermediate sort conveyors 300a-300c and sorters 400a-400d rotate clockwise, the product will be inducted from the intermediate sort conveyor onto a connected sorter, if appropriately determined by coordination of the controller “C”. As the sorter rotates it will drop the product into a bin of one bin location. By making one or more loops around the sorter, while additional product is being inducted and other product is being ejected into bin locations, the controller “C” can determine the proper drop off location of the inducted product into an appropriately determined bin, in a sequence, with relation to other product within that bin.

Product that is not inducted from any of the intermediate sort conveyor 300a-300c to adjacent sorters 400a-400d can be discharged onto the intermediate pre-sorter 500, via the respective discharge units 310a, 310b, the transports 600 and induction units 505a, 505b, as shown in the fully integrated system of FIG. 6. In the integrated system of FIG. 6, the intermediate sort conveyors 300a-300c are connected to the intermediate pre-sorter 500, via the respective discharge units 310a, 310b, induction units 505a, 505b and transports 600. In turn, the intermediate pre-sorter 500 is connected to each of the sorters 400a-400d, via the discharge units 510 and transport path 700. In one aspect of the invention, the pre-sorter 500 has multiple inputs and discharges so product retention of product on the pre-sorter 500 is reduced to an absolute minimum.

Sensors such as photodiodes and/or encoders can be used to maintain track of the product throughout the entire integrated system, as generally represented at “P”. In one implementation, the sensors “P” are in communication with the controller “C”. In one example, product may be inducted onto the intermediate sort conveyor, at which time it will pass through (interrupts) a light beam of the photodiode. Using an encoder, and knowing that the product just interrupted a beam of the photodiode, the controller can determine the particular location of the product within the integrated system can implement all of which implemented by those of skill in the art. This same or similar procedure can be used at any location within the integrated system to determine the location of any product within the system.

By using the intermediate pre-sorter 500, any product from any of the unload modules 100a-100f can be inducted onto any of the sorters 400a-400d, via the transports 700. In one embodiment, the transports 700 are maximized to increase throughput to the sorters 400a-400d. Thus, as shown in the fully integrated system of FIG. 6, the strategically placed intermediate components can pass products from any unload module 100a-100f to any sorter 400a-400d to maximize the throughput of the integrated system.

By using the intermediate pre-sorter 500, product can be sorted to a certain depth level (and in embodiments, in a sequence), under control of the controller “C”. By way of illustration, product is first inducted onto one of the intermediate sort conveyors 300a-300c, after product information is obtained by the imaging units and reconciled by the controller “C”. As the intermediate sort conveyors 300a-300c and sorters 400a-400d rotate clockwise, some product will be inducted from the intermediate sort conveyor onto a connected sorter, if appropriate, and remaining product will be inducted onto the pre-sorter 500, under control of the controller “C”. As the pre-sorter 500 rotates it will divert the product onto a respective transport 700 for induction onto one of the sorters 400a-400d, under control of the controller “C”. Once inducted onto the sorters 400a-400d, the product can be ejected into a proper bin location, in sequence or other sort depth, as described above.

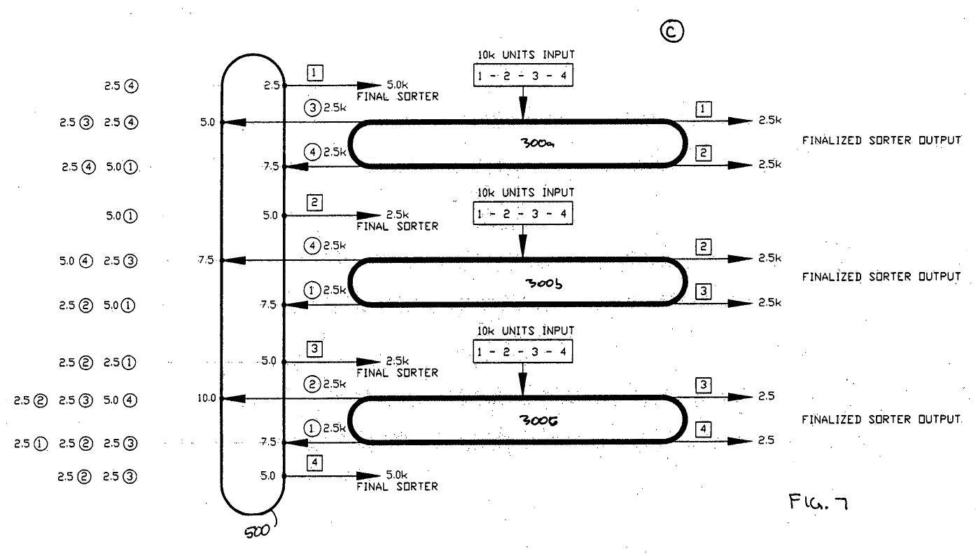

FIG. 7 shows a flow schematic implementing the embodiment of the invention. In the example of FIG. 7, a 30,000 per hour throughput example is shown, with each of the unload modules capable of inputting 10,000 product per hour to the intermediate conveyors 300a-300c. As thus shown representatively in FIG. 7, under control of the controller “C”, product can be diverted from any of the unload modules to any of the sorters via the intermediate conveyors and the intermediate pre-sorters.

In the example of FIG. 7, after the product information is obtained and reconciled, via the controller “C”,
2,500 product are inducted from the intermediate sort conveyor 300a to the first sorter;
2,500 product are inducted from each of the intermediate sort conveyors 300a and 300b to the second, adjacent sorter;
2,500 product are inducted from each of the intermediate sort conveyors 300b and 300c to the third, adjacent sorter; and
2,500 product are inducted from the intermediate sort conveyor 300c to the forth, adjacent sorter.
   The product inducted to each of the sorters are then sequenced or sorted to a certain depth sort during a first pass run, under control of the controller “C”.

The remaining 10,000 product are then inducted onto the intermediate pre-sorter, for transport to another sorter. For example,
2,500 product from the intermediate conveyor 300a are inducted onto the intermediate pre-sorter for destination to the third sorter;
2,500 product from the intermediate conveyor 300a are inducted onto the intermediate pre-sorter for destination to the fourth sorter;
2,500 product from the intermediate conveyor 300b are inducted onto the intermediate pre-sorter for destination to the first sorter;
2,500 product from the intermediate conveyor 300b are inducted onto the intermediate pre-sorter for destination to the fourth sorter;
2,500 product from the intermediate conveyor 300c are inducted onto the intermediate pre-sorter for destination to the second sorter; and
2,500 product from the intermediate conveyor 300c are inducted onto the intermediate pre-sorter for destination to the first sorter.

In example of FIG. 7, the amount of product increases on the farthest portion of the intermediate sorter, as the product is inducted from each of the successive intermediate conveyors 300a-300c. On the closest side to the conveyors 300a-300c, at a location after the last induction point to the first sorter, the amount of product should be equal to or less than the least amount of product on the farthest side, to prevent bottlenecks.

Also, in the example of FIG. 7, the amount of product inducted onto the intermediate pre-sorter for each particular sorter should equal the number of product inducted from the intermediate pre-sorters. For example, 5,000 product will be inducted onto the fourth sorter from the intermediate pre-sorter, if each of the intermediate conveyors 300a and 300b induct 2,500 product onto the intermediate pre-sorter destined for the fourth sorter. The product that are inducted to each of the sorters are then sequenced or sorted to a certain depth sort during a first pass run, in addition to the previously inducted product, under control of the controller “C”.

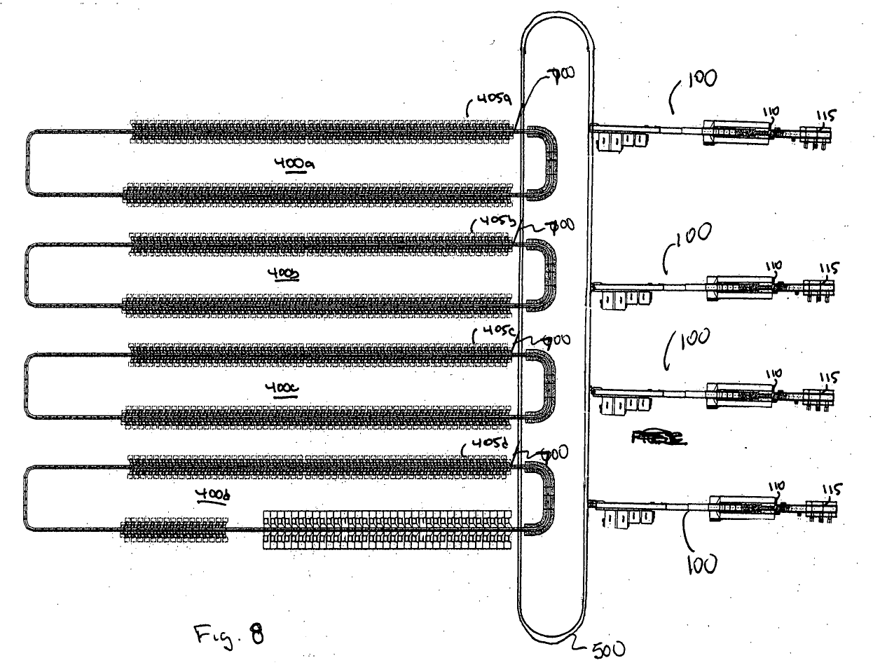

FIG. 8 shows another embodiment of the invention. In the embodiment of FIG. 8, unloading stations 100 are connected to an intermediate sort conveyor. In the illustration of FIG. 8, four unloading stations are shown; however, it should be understood that the more or less than four unloading stations can be provided depending on the required throughput of the system. Also, in the embodiment of FIG. 8, the intermediate sort conveyor may be the intermediate pre-sorter 500.

The intermediate pre-sorter 500, in turn, is connected to one or more sorters 400a, 400b, 400c and 400d, via discharge transports 700. It should be understood that two or more sorters may be used in the implementation of FIG. 8. Additionally, it should be understood by those of skill in the art that the intermediate pre-sorter 500 may include multiple inputs and discharges so product retention of product on the intermediate pre-sorter 500 is reduced to an absolute minimum.

By using the intermediate pre-sorter 500, any product from any of the unload modules can be inducted onto any of the sorters 400a-400d, via the transports 700 and under control of the control “C”. By way of illustration, product is first inducted onto the intermediate pre-sorter 500, after product information is obtained by the imaging units and reconciled by the controller “C”. As the intermediate pre-sorter 500 and sorters 400a-400d rotate, some will be inducted from the intermediate pre-sort conveyor onto the appropriate sorter, under control of the controller “C”. Once inducted onto the sorters 400a-400d, the product can be ejected into a proper bin location, in sequence or other sort depth, as described herein.

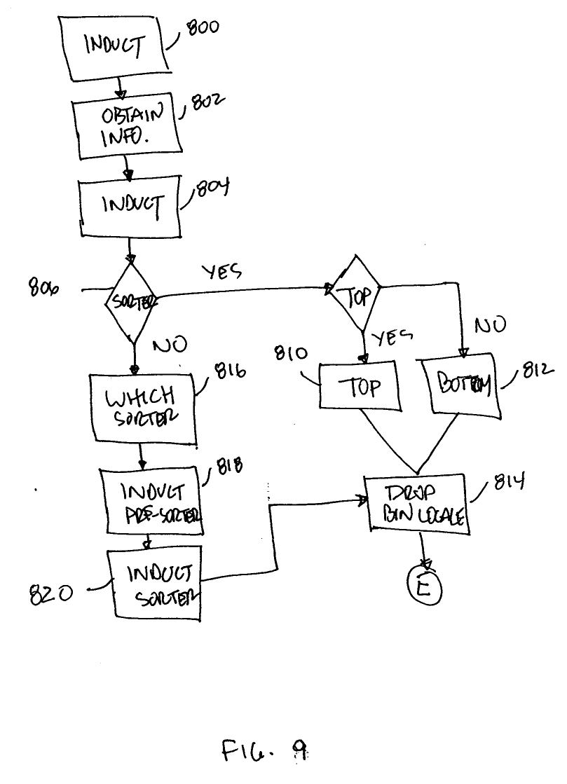

FIG. 9 represents flow steps in accordance with steps of an embodiment of the invention. The flow steps of FIG. 8 may represent a high-level block diagram, representing the system of the invention. The flow of FIG. 8 may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The steps of these figures are not limited to the sequence provided herein.

At step 800, the product is inducted into the unload modules, where the product is singulated into a stream. At step 802, an imaging unit captures or obtains product information, which is provided to the controller. At step 804, the product is inducted onto an intermediate sort conveyor. At step 806, a determination is made as to whether the product should be inducted onto an adjacent sorter, for sequencing or to another sort depth. If the determination is affirmative, a determination is then made as to whether the product should be inducted onto an upper or lower sorter, both adjacent to the intermediate sort conveyor, at step 808. This determination is made based on the product information of the product.

If the product is to be inducted onto the top sorter, at step 810, the product is inducted onto the top sorter at an appropriate time and location. Likewise, if the product is to be inducted onto the bottom sorter, at step 812, the product is inducted onto the bottom sorter at an appropriate time and location. At step 814, the product is dropped into an appropriate bin location, in a sequence or certain sort depth with respect to other product, under coordination of the controller.

If the product is to be inducted onto a non-adjacent sorter, the process continues at step 816. At step 816, a determination is made, based on product information, to transport the product to one of the non-adjacent sorters. At step 818, the product is inducted onto the intermediate pre-sorter and transported to the appropriately determined sorter for induction. At step 820, the product is inducted onto the appropriate sorter, from the intermediate pre-sorter. The process then returns to step 814, wherein the product is dropped into an appropriate bin location, in a sequence or certain sort depth with respect to other product. The process then ends, at step “E”.

While the invention has been described in terms of embodiments, those skilled in the art will recognize that the invention can be practiced with modification within the spirit and scope of the appended claims.

What is claimed is:

1. An apparatus, comprising:
at least one unload module;
at least two sorters; and
an intermediate sort conveyor configured to receive product from the at least one unload module and divert the product to either of the at least two sorters via a plurality of induction units in a transportation path with the at least two sorters.

2. The apparatus of claim 1, further comprising a second intermediate sort conveyor and a third intermediate sort conveyor, wherein the at least two sorters include four sorters and the intermediate sort conveyor is positioned adjacent a first sorter and a second sorter of the four sorters, the second intermediate sort conveyor is positioned adjacent the second sorter and a third sorter of the four sorters and the third intermediate conveyor is positioned adjacent the third sorter and a fourth sorter of the four sorters.

3. The apparatus of claim 2, wherein an output of the at least one unload module does not exceed a throughput of the four sorters.

4. The apparatus of claim 1, wherein the intermediate sort conveyor is a looped configuration and the plurality of induction units include a first number of induction units positioned on a first side of the looped configuration and a second number of induction units are positioned on a second, opposing side of the looped configuration.

5. The apparatus of claim 1, further comprising a second intermediate sort conveyor, wherein:
the at least two sorters include at least three sorters, the intermediate sort conveyor is positioned between a first sorter and a second sorter of the at least three sorters and the second intermediate sort conveyor is positioned between the second sorter and a third sorter of the at least three sorters; and
the intermediate sort conveyor and the second intermediate sort conveyor comprise a plurality of discharge units diverting the product away from the at least three sorters.

6. The apparatus of claim 5, further comprising an intermediate pre-sorter linked to the plurality of discharge units of the intermediate sort conveyor and the second intermediate sort conveyor, the intermediate pre-sorter configured in a loop configuration and configured to discharge the product received from the intermediate sort conveyor to the third sorter and the product received from the second intermediate sort conveyor to the first sorter.

7. The apparatus of claim 6, further comprising a controller which is configurable to coordinate:
discharge of product from the intermediate sort conveyor to the first sorter and the second sorter based on obtained product information;
sort of the discharged product using the first sorter and the second sorter;
discharge of remaining product on the intermediate sort conveyor to the pre-sorter;
transport and induct of the remaining product onto the third sorter; and
sorting the remaining product using the third sorter.

8. The apparatus of claim 7, wherein the controller is further configurable to coordinate:
discharge of other product from the second intermediate sort conveyor to the second sorter and the third sorter based on obtained product information;
sort of the discharged other product using the second sorter and the third sorter;
discharge of remaining other product from the second intermediate sort conveyor to the pre-sorter;
transport and induct of the remaining other product onto the first sorter; and
sort the remaining other product using the first sorter.

9. The apparatus of claim 1, further comprising a controller which is configurable to coordinate product being inducted onto one of the at least two sorters from the intermediate sort conveyor based on product information of the product reconciled by the controller, and coordinating sorting of the product using the at least two sorters.

10. The apparatus of claim 1, wherein the product is mail.

11. The apparatus of claim 1, further comprising at least one sensor to determine a position of the product.

12. The apparatus of claim 1, further comprising a recirculating line connected between one of the least two sorters and one of the at least one unload module.

13. The apparatus of claim 1, wherein the at least two sorters are at least three sorters and the at least one unload module is at least two unload modules, and the intermediate sort conveyor is further configured to receive product from the at least two unload module and divert the product to any of the least three sorters via a plurality of induction units.

14. A system for sorting product, comprising:
at least three sorters, including a first sorter, a second sorter and a third sorter;
a first intermediate sort conveyor having induction units for inducting product to either of the first sorter and the second sorter;
a second intermediate sort conveying having induction units for inducting product to either of the second sorter and the third sorter; and
a pre-sorter loop configured to:
receive non-inducted product from the first intermediate sort conveyor which is to be inducted onto the third sorter;
receive non-inducted product from the second intermediate sort conveyor which is to be inducted onto the first sorter; and
discharge non-inducted product from the first and second intermediate sort conveyors to the first sorter and the third sorter.

15. The system of claim 14, further comprising a controller which is configurable, based on product information of the product, to coordinate:
the induction of the product onto the first sorter and the second sorter from the first intermediate sort conveyor;
the induction of the product onto the second sorter and the third sorter from the second intermediate sort conveyor;
the discharge of the non-inducted product from the first and second intermediate sort conveyors onto the pre-sorter loop;
discharge of the non-inducted product from the pre-sort loop to the first sorter and the third sorter; and
sorting to a certain depth level of the inducted product and the non-inducted product by the first, second and third sorters.

16. The system of claim 15, wherein the first and second intermediate conveyors are configured in a loop.

17. The system of claim 14, wherein the first intermediate sort conveyor is positioned between the first sorter and the second sorter and the second intermediate sort conveyor is positioned between the second sorter and the third sorter.

18. The system of claim 14, further comprising at least one sensor to determine a position of the product.

19. The system of claim 14, wherein the product are mail pieces.

20. A system for sorting mail, comprising:
a sorting mechanism comprising n+1 sorters;
an intermediate conveying system having (n+1)-1 conveyors, each of the conveyors being alternatively positioned with the n+1 sorters and having induction units to induct mail pieces to each adjacent sorter; and
at least one unload module configured to induct the mail pieces to each of the (n+1)-1 conveyors, the at least one unload module configured to have a capacity which is equal to or less than a throughput of the n+1 sorters.

21. The system of claim 20, further comprising a pre-sorter loop in a transportation path of the n+1 sorters and the (n+1)-1 conveyors, wherein:
the n+1 sorters comprise:
a first sorter configured in a loop;
a second sorter configured in a loop;
a third sorter configured in a loop; and
a fourth sorter configured in a loop;
the (n+1)-1 conveyors comprise:
a first intermediate conveyor configured to induct the mail pieces to the first sorter and the second sorter and to discharge mail pieces for sorting by the third sorter and the fourth sorter to the pre-sorter loop;
a second intermediate conveyor configured to induct the mail pieces to the second sorter and the third sorter and to discharge mail pieces for sorting by the first sorter and the fourth sorter to the pre-sorter loop; and
a third intermediate conveyor configured to induct the mail pieces to the third sorter and the fourth sorter and to discharge mail pieces for sorting by the first sorter and the second sorter to the pre-sorter loop.

22. The system of claim 21, further comprising a controller for coordinating the sorting of the mail pieces by use of the n+1 sorters, based on the mail information.

23. A method of sorting mail using a plurality of sorters, comprising:
obtaining product information from mail pieces;
inducting the mail pieces onto at least one intermediate sort conveyor;
determining whether the mail pieces should be inducted onto one of at least two adjacent sorters, for sequencing or sorting to another depth level; and
at least one of:
if the determining step is affirmative, inducting the mail pieces onto one of at least two adjacent sorters for the sequencing or sorting to another depth level;
if the determining step is negative, inducting the mail pieces onto an intermediate conveyance from the at least one intermediate sort conveyors, and transporting the mail pieces to another sorter, which was not originally in a transportation path with the at least one intermediate sort conveyors, and inducting the mail pieces onto the another sorter.
